(19) United States
(12) Patent Application Publication
(10) Pub. No.: US 2015/0105484 A1
(43) Pub. Date: Apr. 16, 2015

(54) FLAME RETARDANT THERMOPLASTIC ELASTOMERS FOR EXTRUSION OR INJECTION MOLDING

(71) Applicant: FRX Polymers, Inc., Chelmsford, MA (US)

(72) Inventors: Xiudong SUN, Weston, MA (US); Zhiyuan LAN, Lowell, MA (US); Jan-Pleun LENS, Boston, MA (US)

(21) Appl. No.: 14/514,015

(22) Filed: Oct. 14, 2014

Related U.S. Application Data
(60) Provisional application No. 61/890,409, filed on Oct. 14, 2013.

(51) Int. Cl. C08K 5/00; C08K 5/5313; C08K 5/3492

(52) U.S. Cl. CPC C08K 5/0066; C08K 5/34922; C08K 5/5313
USPC 521/85; 524/133; 524/100

(57) ABSTRACT

Disclosed are new compositions consisting of mixtures of flame retardants for thermoplastic elastomers with the addition of phosphinate salt and phosphonate oligomers, polymers or copolymers, and optionally additional flame retardants. The compositions exhibit an excellent combination of processing characteristics, thermal and mechanical properties, and are flame retardant. Further disclosed are articles of manufacture produced from these materials, such as fibers, films, coated substrates, moldings, foams, fiber-reinforced articles, wires, and cables including these compositions, or any combination thereof.

### CROSS-REFERENCE TO RELATED APPLICATIONS

This application claims priority to U.S. Provisional No. 61/890,409 entitled “Flame Retardant Thermoplastic Elastomers for Extrusion or Injection Molding” filed Oct. 14, 2013, which is hereby incorporated by reference in its entirety.

### GOVERNMENT INTERESTS

Not Applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

Not applicable

### SUMMARY OF THE INVENTION

In some embodiments, a plastic molding composition may include a thermoplastic elastomer, a phosphinate salt, a phosphonate component that includes an oligomeric phosphonate, polyphosphonate or copolyphosphonate, a metal hydroxide or metal oxide hydroxide, and melamine derivatives.

Various embodiments are directed to a plastic molding composition containing a thermoplastic polyurethane (TPU), about 2 wt. % to about 25 wt. % phosphinate salt, and about 1 wt. % to about 15 wt. % of a phosphonate component selected from the group consisting of oligomeric phosphonates, polyphosphonates, and copolyphosphonates, wherein the plastic molding composition has a phosphorous content of about 0.5 wt. % to about 5 wt. %. In some embodiments, the phosphonate component may be polymer or oligomer having units of Formula I:

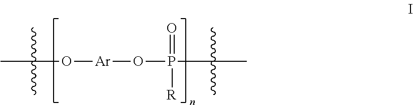

wherein Ar is an aromatic group; R is a C₁₋₂₀ alkyl, C₂₋₂₀ alkene, C₂₋₂₀ alkyne, C₅₋₂₀ cycloalkyl, or C₆₋₂₀ aryl; and n is an integer from 1 to about 20. In some embodiments, —O—Ar—O— may be derived from a compound selected from the group consisting of resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof. In certain embodiments, the phosphonate component is a copolyphosphonate having a ratio of phosphonate to carbonate of about 95% to 5% to about 40% to 60%. The phosphinate salt in some embodiments may be aluminum diethylphosphinate. In particular embodiments, the composition may include about 0.1 wt. % to about 30 wt. % of a melamine containing component such as, for example, melamine cyanurate, melamine polyphosphate, and combinations thereof. In some embodiments, the composition may further include a metal hydroxide or metal oxide hydroxide, and in still further embodiments, the composition may include, for example, glass fiber, carbon fiber, inorganic fiber, organic fiber, fillers, surfactants, organic binders, polymeric binders, crosslinking agents, coupling agents, anti-dripping agents, colorants, inks, dyes, antioxidants, anti-hydrolysis agents, or combinations thereof. Other embodiments include an article of manufacture including such compositions, and in various embodiments, the article may be a fiber, a film, an extruded sheet, a coating, an adhesive, a molding, a foam, a fiber reinforced article, or a part of a wire or cable.

Various other embodiments are directed to a plastic molding composition including a thermoplastic polyester elastomer (TPE-E), about 5 wt. % to about 25 wt. % phosphinate salt, about 2 wt. % to about 15 wt. % of a phosphonate component selected from the group consisting of oligomeric phosphonates, polyphosphonates, and copolyphosphonates, and about 0.1 wt. % to about 30 wt. % of a metal hydroxide or metal oxide hydroxide. In some embodiments, the metal hydroxide or metal oxide hydroxide may be aluminum hydroxide. In particular embodiments, the phosphonate component may be a polymer or oligomer having units of Formula I:

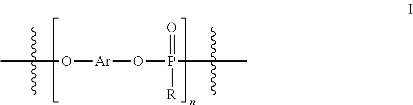

wherein Ar is an aromatic group; R is a C₁₋₂₀ alkyl, C₂₋₂₀ alkene, C₂₋₂₀ alkyne, C₅₋₂₀ cycloalkyl, or C₆₋₂₀ aryl; and n is an integer from 1 to about 20. In some embodiments, —O—Ar—O— may be derived from a compound selected from the group consisting of resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof. In certain embodiments, the phosphonate component is a copolyphosphonate having a ratio of phosphonate to carbonate of about 95% to 5% to about 40% to 60%. The phosphinate salt in some embodiments may be aluminum diethylphosphinate. In certain embodiments, the composition may include about 0.1 wt. % to about 10 wt. % of a melamine containing component such as, for example, melamine cyanurate, melamine polyphosphate, and combinations thereof. In some embodiments, the composition may further include glass fiber, carbon fiber, inorganic fiber, organic fiber, fillers, surfactants, organic binders, polymeric binders, crosslinking agents, coupling agents, anti-dripping agents, colorants, inks, dyes, antioxidants, anti-hydrolysis agents, or combinations thereof. Additional embodiments are directed to an article of manufacture including such compositions, and in certain embodiments, the article may be a fiber, a film, an extruded sheet, a coating, an adhesive, a molding, a foam, a fiber reinforced article, or a part of a wire or cable.

### DESCRIPTION OF THE DRAWINGS

Not Applicable

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

The term “aliphatic diol” is meant to encompass any aliphatic or predominately aliphatic compound with at least two associated hydroxyl substitutions. Aliphatic diols may include telechelic ester oligomers with hydroxyl terminal groups or any telechelic oligomer with hydroxyl terminal groups, diol monomers such as 1,4-cyclohexyldimethanol, 1,4-butane diol, 1,3-propane diol, and ethylene diol. The diol functionality may be protected in the form of a trimethylsilyl group.

The term “aromatic diol” is meant to encompass any aromatic or predominately aromatic compound with at least two associated hydroxyl substitutions. In certain embodiments, the aromatic diol may have two or more phenolic hydroxyl groups. Examples of aromatic diols include, but are not limited to, 4,4′-dihydroxybiphenyl, hydroquinone, resorcinol, methyl hydroquinone, chlorohydroquinone, acetoxyhydroquinone, nitrohydroquinone, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis(4-hydroxyphenyl)methane, bis(4-hydroxy-3,5-dimethylphenyl)methane, bis(4-hydroxy-3,5-dichlorophenyl)methane, bis(4-hydroxy-3,5-dibromophenyl)methane, bis(4-hydroxy-3-methylphenyl)methane, bis(4-hydroxy-3-chlorophenyl)methane, 1,1-bis(4-hydroxyphenyl)cyclohexane, bis(4-hydroxyphenyl)ketone, bis(4-hydroxy-3,5-dimethylphenyl)ketone, bis(4-hydroxy-3,5-dichlorophenyl)ketone, bis(4-hydroxyphenyl)sulfide and bis(4-hydroxyphenyl)sulfone, phenolphthalein, 4,4′-thiodiphenol, 4,4′-sulfonyldiphenol, 4,4,-dihydroxydiphenylether, and 1,1-bis-(4-hydroxyphenyl)-3,3,5-trimethylcyclohexane. In some embodiments, a single aromatic diol may be used, and in other embodiments, various combinations of such aromatic diols may be incorporated into the polyester. In certain embodiments, the aromatic diol may be bisphenol A, bisphenol F, hydroquinone, resorcinol, 2,6-dihydroxynaphthalene, 1,1-bis(4-hydroyphenyl)-3,3,5-trimethylcyclohexane (TMC bisphenol) and bis(4-hydroxyphenyl)sulfone, can be used. In further embodiments, the diol functionality may be in the form of a trimethylsilyl group.

Polyesters can be synthesized using a dicarbonic acid or a dicarbonic acid derivative and a diol or using AB monomers. The term “AB monomer” is meant to encompass any difunctional monomers that can react to form a polyester. Examples include but are not limited to, hydroxycarboxylic acids or derivatives thereof (i.e. acid halides, esters, anhydrides) with at least one each of a hydroxyl or protected hydroxyl group and a carboxylic acid, ester, acid halide or other carboxylic acid derivative group. Examples may include but are not limited to, para-hydroxybenzoic acid, meta-hydroxybenzoic acid, 2-hydroxy-6-naphthoic acid, 2-hydroxy-3-naphthoic acid, 1-hydroxy-4-naphthoic acid, 4-hydroxy-4′-carboxydiphenyl ether, 2,6-dichloro-para-hydroxybenzoic acid, 2-dichloro-para-hydroxybenzoic acid, 2,6-difluoro-para-hydroxybenzoic acid and 4-hydroxy-4′-biphenylcarboxylic acid. As with the aromatic and aliphatic diols, these compounds may be used individually or in a combination of two or more different aromatic hydroxycarboxylic acids. In certain embodiments, the aromatic hydroxycarboxylic acid may be para-hydroxybenzoic acid, 2-hydroxy-6-naphthoic acid, or a combination thereof. Additional AB monomers can include cyclic lactones such as caprolactone and others, lactides such as lactide and others. The AB monomers can be used alone, combined with one another or used in combination with other monomers for polyester synthesis.

The term “dicarboxylic acid” is meant to encompass any aromatic or aliphatic compound with at least two associated carboxylic acid substitutions or derivatives of carboxylic acid groups such as anhydrides, esters, acid halides, and the like. The dicarboxylic acid may include an aliphatic dicarboxylic acid (e.g., a C₄₋₄₀ aliphatic dicarboxylic acid such as succinic acid, glutaric acid, adipic acid, pimelic acid, suberic acid, azelaic acid, sebacic acid, undecanedicarboxylic acid, dodecanedicarboxylic acid, hexadecanedicarboxylic acid, or dimeric acid such as a C₄₋₁₄ dicarboxylic acid), an alicyclic dicarboxylic acid (e.g., a C₅₋₁₂ alicyclic dicarboxylic acid such as hexahydrophthalic acid, hexahydroisophthalic acid, or hexahydroterephthalic acid), an aromatic dicarboxylic acid other than terephthalic acid (e.g., a C₈₋₁₆ aromatic dicarboxylic acid such as phthalic acid, isophthalic acid; a naphthalenedicarboxylic acid such as 2,6-naphthalenedicarboxylic acid; and 4,4′-diphenyldicarboxylic acid, 4,4′-diphenoxyetherdicarboxylic acid, 4,4′-diphenyletherdicarboxylic acid, 4,4′-diphenylmethanedicarboxylic acid, or 4,4′-diphenylketonedicarboxylic acid), a reactive derivative thereof, or a combination thereof. A reactive derivate may be a derivative capable of forming an ester, for example, a lower alkyl ester (e.g., a C₁₋₄ alkyl ester of phthalic acid or isophthalic acid, such as dimethyl phthalate or dimethyl isophthafate (DMI); an acid chloride; an acid anhydride; and a derivative capable of forming an ester such as an alkyl-, alkoxy-, or halogen-substituted compound of the dicarboxylic acid or a diol.

The term “alkyl” or “alkyl group” refers to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. “Cycloalkyl” or “cycloalkyl groups” are branched or unbranched hydrocarbons in which all or some of the carbons are arranged in a ring such as but not limited to cyclopentyl, cyclohexyl, methylcyclohexyl and the like. The term “lower alkyl” includes an alkyl group of 1 to 10 carbon atoms.

The term “aryl” or “aryl group” refers to monovalent aromatic hydrocarbon radicals or groups consisting of one or more fused rings in which at least one ring is aromatic in nature. Aryls may include but are not limited to phenyl, napthyl, biphenyl ring systems and the like. The aryl group may be unsubstituted or substituted with a variety of substituents including but not limited to alkyl, alkenyl, halide, benzylic, alkyl or aromatic ether, nitro, cyano and the like and combinations thereof.

“Substituent” refers to a molecular group that replaces a hydrogen in a compound and may include but are not limited to trifluoromethyl, nitro, cyano, C₁-C₂₀ alkyl, aromatic or aryl, halide (F, Cl, Br, I), C₁-C₂₀ alkyl ether, C₁-C₂₀ alkyl ester, benzyl halide, benzyl ether, aromatic or aryl ether, hydroxy, alkoxy, amino, alkylamino (—NHR′), dialkylamino (—NR′R″) or other groups which do not interfere with the formation of the intended product.

As defined herein, an “arylol” or an “arylol group” is an aryl group with a hydroxyl, OH substituent on the aryl ring. Non-limiting examples of an arylol are phenol, naphthol, and the like. A wide variety of arlyols may be used in the embodiments of the invention and are commercially available.

The term “alkanol” or “alkanol group” refers to a compound including an alkyl of 1 to 20 carbon atoms or more having at least one hydroxyl group substituent. Examples of alkanols include but are not limited to methanol, ethanol, 1- and 2-propanol, 1,1-dimethylethanol, hexanol, octanol and the like. Alkanol groups may be optionally substituted with substituents as described above.

The term “alkenol” or “alkenol group” refers to a compound including an alkene 2 to 20 carbon atoms or more having at least one hydroxyl group substituent. The hydroxyl may be arranged in either isomeric configuration (cis or trans). Alkenols may be further substituted with one or more substituents as described above and may be used in place of alkenols in some embodiments of the invention. Alkenols are known to those skilled in the art and many are readily available commercially.

As used herein, the term “about” means plus or minus 10% of the numerical value of the number with which it is being used. Therefore, about 50% means in the range of 45%-55%.

The terms “flame retardant,” “flame resistant,” “fire resistant,” or “fire resistance,” as used herein, means that the composition exhibits a limiting oxygen index (LOI) of at least 27. “Flame retardant,” “flame resistant,” “fire resistant,” or “fire resistance,” may also refer to the flame reference standard ASTM D6413-99 for textile compositions, flame persistent test NF P 92-504, and similar standards for flame resistant fibers and textiles. Fire resistance may also be tested by measuring the after-burning time in accordance with the UL test (Subject 94). In this test, the tested materials are given classifications of UL-94 V-0, UL-94 V-1 and UL-94 V-2 on the basis of the results obtained with the test specimens. The results will depend on the thickness of the test samples. Generally, better flame retardant results are obtained with thicker test samples. Briefly, the criteria for each of these UL-94-V-classifications are as follows:

UL-94 V-0: the maximum burning time after removal of the ignition flame should not exceed 10 seconds and the total burning time (t1+t2) for five tested specimen should not exceed 50 seconds. None of the test specimens should release any drips which ignite absorbent cotton wool.

UL-94 V-1: the maximum burning time after removal of the ignition flame should not exceed 30 seconds and the total burning time (t1+t2) for five tested specimen should not exceed 250 seconds. None of the test specimens should release any drips which ignite absorbent cotton wool.

UL-94 V-2: the maximum burning time after removal of the ignition flame should not exceed 30 seconds and the total burning time (t1+t2) for five tested specimen should not exceed 250 seconds. The test specimens may release flaming particles, which ignite absorbent cotton wool.

Fire resistance may also be tested by measuring after-burning time. These test methods provide a laboratory test procedure for measuring and comparing the surface flammability of materials when exposed to a prescribed level of radiant heat energy to measure the surface flammability of materials when exposed to fire. The test is conducted using small specimens that are representative, to the extent possible, of the material or assembly being evaluated. The rate at which flames travel along surfaces depends upon the physical and thermal properties of the material, product or assembly under test, the specimen mounting method and orientation, the type and level of fire or heat exposure, the availability of air, and properties of the surrounding enclosure. If different test conditions are substituted or the end-use conditions are changed, it may not always be possible by or from this test to predict changes in the fire-test-response characteristics measured. Therefore, the results are valid only for the fire test exposure conditions described in this procedure. The state-of-the-art approach to rendering polyesters flame retardant is to use additives such as brominated compounds or compounds containing aluminum and/or phosphorus. Use of the additives with polyesters has a deleterious effect on the processing characteristics and/or the mechanical performance of fibers produced from them. In addition, some of these compounds are toxic, and can leach into the environment over time making their use less desirable. In some countries, certain brominated additives and aluminum and/or phosphorus containing additives are being phased-out of use because of environmental concerns.

The term “toughness,” as used herein, is meant to imply that the material is resistant to breaking or fracturing when stressed or impacted. There are a variety of standardized tests available to determine the toughness of a material. Generally, toughness is determined qualitatively using a film or a molded specimen.

The phrase “low viscosity when sheared,” “shear thinning,” or similar phrases, as used herein, is meant to imply that when the material is melted and subjected to a shearing force, such as that encountered with certain types of mixers or when the melt is forced with pressure through a die or body having a small orifice, the viscosity is reduced. Shear thinning behavior may be transferred to blends of materials. Shear thinning can be measured using standardized methods such as the Shear Thinning Index (STI). STI represents the ratio of the viscosity at a low rpm shear to the viscosity at a high rpm, generally, about ten times greater than the low rotational speed. For example, low shear may be 1 rpm and high shear can be 10 rpm. The higher the STI value, the more shear thinning the material exhibits.

The term “fiber” means a monofilament or multi-filament continuous or chopped strand of any diameter and shape fabricated by any known method from a polymeric composition.

“Number averaged molecular weight” can be determined by relative viscosity (ηᵣₑₗ) and/or gel permeation chromatography (GPC). Unless otherwise indicated, the values recited are based on polystyrene standards. Relative viscosity (ηᵣₑₗ) is a measurement that is indicative of the molecular weight of a polymer and is generally measured by dissolving a known quantity of polymer in a solvent and comparing the time it takes for this solution and the neat solvent to travel through a capillary (i.e., viscometer) at a constant temperature. It is also well known that a low relative viscosity is indicative of a low molecular weight polymer. Low molecular weight may causes mechanical properties such as strength and toughness to be worse compared to higher molecular weight samples of the same polymers. Therefore, reducing the relative viscosity of a polymer would be expected to result in a reduction in mechanical properties, for example, poor strength or toughness compared to the same composition which has a higher relative viscosity.

GPC is a type of chromatography that separates polymers by size. This technique provides information about the molecular weight and molecular weight distribution of the polymer, i.e., the polydispersity index (PDI).

A “flame retardant” refers to any compound that inhibits, prevents, or reduces the spread of fire.

A “thermoplastic polymer” refers to any polymer that becomes more flexible when heated, and returns back to a solid state after it is cooled.

A “phosphinate” refers to any inorganic phosphinate salt, organic phosphinate salt, phosphinate esters or salts of phosphinic acids.

Various embodiments of the invention are directed to polymer compositions for mixtures of flame retardant compositions including thermoplastic polyester elastomers (TPE-E) or thermoplastic polyurethanes (TPU) and phosphinate salts, metal hydroxides or metal oxide hydroxides, and one or more phosphonate components such as oligomeric phosphonates, phosphonate polymers, or copolyphosphonates. In some embodiments, the metal hydroxide may be aluminum hydroxide (ATH). Such compositions generally provide improved flame retardancy over polymer compositions including phosphinate salts and other flame retardant additives, while providing improved processability and excellent physical properties.

The TPE-E may be a block copolymer having a structure in which a polyester hard block bonds with a polyester soft block through an ester bond. In some embodiments, according to the type of soft block, the TPE-E may be polyether-based. In other embodiments, according to the type of soft block, the TPE-E may be polyester-based.

In some embodiments, the TPE-E may be composed of “aromatic polyesters.” An aromatic polyester may have at least one aromatic monomer component. The aromatic monomer component may include an aromatic diol and a reactive derivative thereof, an aromatic dicarboxylic acid and terephthalic acid (and a reactive derivative of such an aromatic dicarboxylic acid), an aromatic hydroxycarboxylic acid [for example, hydroxybenzoic acid, hydroxynaphthoic acid, 4-carboxy-4′-hydroxy-biphenyl, and a derivative of such a hydroxycarboxylic acid (e.g., an alkyl-, alkoxy-, or halogen-substituted compound)], or a combination thereof. In the aromatic polyester, a copolymerizable monomer (including a copolymerizable monomer, and in addition, 1,4-butanediol, terephthalic acid, and the like) may be used in combination.

In some embodiments, the aromatic polyester may use at least one of the aromatic monomer components as a monomer component. The aromatic polyester may be a fully aromatic polyester (e.g., a polyester of an aromatic dicarboxylic acid and an aromatic diol, and a polyester of an aromatic hydroxycarboxylic acid) or may be a polyester of an aromatic dicarboxylic acid and a non-aromatic diol (e.g., 1,4-butanediol, and an aliphatic diol or an alicyclic diol), a polyester of a non-aromatic dicarboxylic acid (e.g., an aliphatic dicarboxylic acid) and an aromatic diol, and a polyester of an aromatic hydroxycarboxylic acid and a non-aromatic hydroxycarboxylic acid (e.g., an aliphatic hydroxycarboxylic acid such as glycolic acid or hydroxycaproic acid).

In some embodiments, a crystalline aromatic polyester may be the hard polyester. The crystalline aromatic polyester may be a polyalkylene arylate and a liquid crystal polyester. The polyalkylene arylate may be a polyC₂₋₄alkylene arylate and a modified polyC₂₋₄alkylene arylate. The polyC₂₋₄alkylene arylate may be a polyethylene terephthalate (PET), a polybutylene terephthalate (PBT), a polyethylene naphthalate, a polybutylene naphthalate, or a combination thereof. The modified polyC₂₋₄alkylene arylate may be a polyC₂₋₄alkylene arylate modified. The modified polyC₂₋₄alkylene arylate may be covalently associated with a copolymerizable component by copolymerization. The modified polyC₂₋₄alkylene arylate may be covalently associated with about 1 mol % to about 30 mol % of a copolymerizable component, about 3 mol % to about 25 mol %, about 5 mol % to about 20 mol %, about 10 mol % to about 15 mol %, or a value between any of these ranges. The copolymerizable component may be a copolymerizable monomer, such as, isophthalic acid. The liquid crystal polyester may be a polybutylene terephthalate or the like.

In some embodiments, a soft polyester constituting the soft block of the polyester-based elastomer may be softer than the hard polyester constituting the hard block. In some embodiments, the soft polyester may include a polyester obtained from at least an aliphatic monomer component, for example, an aliphatic diol (e.g., 1,4-butanediol, an aliphatic diol, and a reactive derivative thereof), an aliphatic dicarboxylic acid (e.g., an aliphatic dicarboxylic acid and a reactive derivative thereof), an aliphatic hydroxycarboxylic acid (e.g., glycolic acid and hydroxycaproic acid), and a lactone. In some embodiments, the aliphatic monomer component may be used in combination with a copolymerizable monomer. The copolymerizable monomer may be a non-aromatic monomer component (e.g., an alicyclic diol or an alicyclic dicarboxylic acid and a reactive derivative thereof).

In some embodiments, the soft polyester may be an amorphous polyester. The amorphous polyester may be an aliphatic polyester of an aliphatic dicarboxylic acid and an aliphatic diol, and a polylactone (a ring-opening polymer of the lactone).

In some embodiments, the soft segment of the polyether-based elastomer may have at least a polyether unit. The polyether may be an aliphatic polyether having a polyoxyalkylene unit (e.g., a polyoxyalkylene glycol or a polyC₂₋₆alkylene glycol), a polyester obtained by using the polyether, or a combination thereof. In certain embodiments, the soft segment may be a polyC₂₋₄alkylene glycol, such as a polyoxyethylene glycol, a polyoxypropylene glycol, or a polyoxytetramethylene glycol. The polyester obtained by using the polyether may include a polyester of the polyether (e.g., a polyoxyalkylene glycol), a dicarboxylic acid (usually, a non-aromatic dicarboxylic acid, e.g., an aliphatic or an alicyclic dicarboxylic acid and a reactive derivative thereof), and the like. In certain embodiments, the polyester soft block may have at least one unit selected from the group consisting of a polyether unit, an aliphatic polyether unit, a polyester unit obtained by using an aliphatic polyether, and an aliphatic polyester unit.

Examples of the TPE-E may include a polyester-based (polyesterpolyester-based) thermoplastic elastomer and a polyether-based (polyester-polyether-based) thermoplastic elastomer. The polyester-based elastomer may include a block copolymer of a hard segment that includes an aromatic crystalline polyester and a soft segment that includes an aliphatic polyester. The aromatic crystalline polyester may be a polyC₂₋₄ alkylene arylate (e.g., a homopolymer having a polybutylene terephthalate unit or a copolymer having a copolymerizable component (such as ethylene glycol or isophthalic acid)) or a liquid crystal polyester. The soft segment that includes an aliphatic polyester may be a polyester of a C₂₋₆alkylene glycol (such as a polyethylene adipate or a polybutylene adipate) and a C₆₋₁₂alkanedicarboxylic acid. The polyether based elastomer may include a block copolymer of a hard segment that includes the aromatic crystalline polyester or the liquid crystal polyester and a soft segment that may include a polyether. In some embodiments, the polyether may be a polyoxyC₂₋₄alkylene glycol, such as a polytetramethylene ether glycol. Examples of a polytetramethylene ether glycol include, but are not limited to, a polyester of a polyoxyalkylene glycol and a dicarboxylic acid.

In some embodiments, the TPE-E may include a block copolymer of (1) a polyalkylene arylate hard block and (2) a polyester soft block that comprises a polycaprolactone, an aliphatic polyether having an oxyC₂₋₆alkylene unit (e.g., a polyC₂₋₆alkylene glycol), an aliphatic polyester, or a combination thereof.

In the TPE-E, the weight ratio of the hard segment to the soft segment may be about 10/90 to about 90/10, about 20/80 to about 80/20, about 30/70 to about 70/30, about 40/60 to about 60/40, or a ratio between any of these ranges.

Thermoplastic polyurethanes (TPU) are thermoplastic elastomers consisting of linear segmented block copolymers composed of hard and soft segments derived from the monomers used in their synthesis. Polyurethanes are, generally, synthesized by the reaction of a difunctional isocyanate compound, oligomer, or polymer with a difunctional hydroxy compound, oligomer, or polymer or combinations thereof, in the presence of a catalyst. Other additives may also be present during synthesis. Consequently, there are a tremendous number of possible combinations that can be synthesized by varying the chemical structure of the reactants and the molecular weight range of the TPU, and an enormous variety of different TPUs in which the polymer's structure has been manipulated to achieve the desired combination of properties for a specific application. TPUs exhibit many useful properties, including elasticity, transparency, toughness, and resistance to oil, grease and abrasion, and thermoplastic-like processability. An overview of the production, properties and applications of TPUs is given for example in the Plastics Handbook (G. Becker, D. Braun), Volume 7 “Polyurethane”, Munich, Vienna, Carl Hanser Publishing, 1983.

Embodiments of the invention include any TPUs encompassed by the description above, and TPUs prepared from any combination of compounds, oligomers, or polymers. For example, in some embodiments, the TPUs may be prepared from difunctional isocyanates (i.e., diisocyanates) that are aromatic including, but not limited to, diphenylmethane diisocyanate (MDI) or toluene diisocyanate (TDI) or aliphatic, including, but not limited to, hexamethylene diisocyanate (HDI) or isophorone diisocyanate (IPDI). In other embodiments, the difunctional isocyanates may also be polymeric and may include, for example, polymeric diphenylmethane diisocyanate, which is a blend of molecules having two-, three-, and four- or more isocyanate groups, with an average functionality of 2.7. In certain embodiments, the diisocyanates can be modified by partially reacting them with a polyol to form a prepolymer. A “true prepolymer” is formed when the stoichiometric ratio of isocyanate to hydroxyl is equal to 2:1, and a “quasi-prepolymer” is formed when the stoichiometric ratio of isocyanate to hydroxyl groups is greater than 2:1. Such prepolymers can be exposed to moisture to convert the isocyanate to amino groups which subsequently react with remaining isocyanate groups to form a urea linkage.

The other monomer used in the synthesis of TPUs is, generally, a difunctional hydroxyl compound (i.e., diol), oligomer or polymer. Examples of commonly used monomeric diols used in the making of TPUs include, but are not limited to, 1,2-ethylene glycol, 1,4-butanediol, diethylene glycol, glycerine, and trimethylolpropane. Polymeric diols (i.e., polyols) can also be used in the production of TPUs, and are often formed by base-catalyzed addition of propylene oxide and/or ethylene oxide onto a hydroxyl or amine containing initiator, or by polyesterification of a di-acid, such as adipic acid, with glycols, such as ethylene glycol or dipropylene glycol. The most common polyols are polyether polyols, polycarbonate diols and polyester polyols. The molecular weight of the polyols can cover a broad range from oligomeric to high molecular weight polymer.

Catalysts used in the synthesis of TPUs include, but are not limited, to amine compounds and organometallic complexes. Examples of amine catalysts include tertiary amine catalysts such as, but are not limited, to triethylenediamine also known as 1,4-diazabicyclo[2.2.2]octane, dimethylcyclohexylamine (DMCHA), and dimethyl-ethanolamine (DMEA). Organometallic compounds based on mercury, lead, tin (dibutyltin dilaurate), bismuth (bismuth octanoate), and zinc can also be used as polyurethane catalysts. Mercury carboxylates, such as phenylmercuric neodeconate, are particularly effective catalysts. Bismuth and zinc carboxylates have also been used as catalysts in the synthesis of TPUs. Alkyl tin carboxylates, oxides and mercaptides oxides are used including, but not limited to, dibutyltin dilaurate, dioctyltin mercaptide, and dibutyltin oxide.

TPUs may be produced continuously or discontinuously. Thermoplastically processable polyurethane elastomers may be made up either step by step (prepolymer dosing process) or by the simultaneous reaction of all components in one stage (one shot dosing process). The best known production processes are the band process and the extrusion process.

The TPU component of various embodiments of the invention can be any TPU known in the art including but not limited to those described above. For example, the TPUs encompassed by embodiments can include aromatic diisocyanates such as, but not limited to, diphenylmethane diisocyanate (MDI) and toluene diisocyanate (TDI) or aliphatic diiosocynates such as, but not limited to, hexamethylene diisocyanate (HDI) and isophorone diisocyanate (IPDI), or polymeric isocyanates having two-, three-, and four- or more isocyanate groups, and diols including, but are not limited to, 1,2-ethylene glycol, 1,4-butanediol, diethylene glycol, glycerine, and trimethylolpropane or polyols formed by base-catalyzed addition of propylene oxide and/or ethylene oxide onto a hydroxyl or amine containing initiator or polyesterification of a di-acid, such as adipic acid, with glycols, such as ethylene glycol or dipropylene glycol. In particular embodiments, the polyol component may be a polyether polyol, polycarbonate diol, or polyester polyols. More specific TPUs include commercially available TPUs including but not limited to Elastollan (BASF & Elastogran), Pearlthane (Merquinsa), Desmopan (Bayer), Estane (Lubrizol), Pellethane (Lubrizol), New power industrial limited (New Power®), Irogran (Huntsman), Exelast EC (Shin-Etsu Polymer Europe B.V.), Laripur (COIM SpA), Avalon (Huntsman) and Isothane (Greco).

In some embodiments, a flame retardant mixture for thermoplastic elastomers including TPE-E and TPU may include, as a phosphinic acid salt (also referred to as phosphinate salt) of the formula (I) or (II)

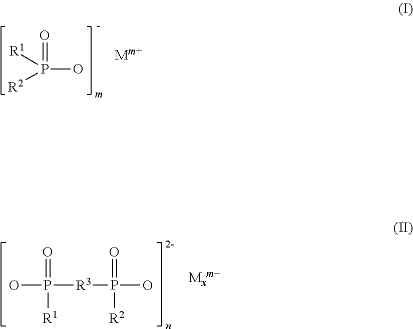

where R¹ and R² are identical or different and are H or C₁-C₆-alkyl, linear or branched, an aryl, or a combination thereof; M is Mg, Ca, Al, Sb, Sn, Ge, Ti, Fe, Zr, Ce, Bi, Sr, Mn, Li, Na, K, Zn, a protonated nitrogen base, or a combination thereof; calcium ions, magnesium ions, aluminum ions, zinc ions, or a combination thereof; m may be from 1 to 4; n may be from 1 to 4; x may be from 1 to 4. In some embodiments, m may be 2 or 3 for formula (I); n may be 1 or 3, and x may be 1 or 2 for formula (II).

The physical form in which the phosphinic salts may be used for the flame retardant and stabilizer combined may vary, depending on the type of polyphosphonate used and on the properties desired. In some embodiments, the phosphinic salts may be milled to give a fine-particle form to achieve better dispersion within the polyphosphonate. Mixtures of various phosphinic salts may also be used.

Salts of the phosphinic acids may be prepared by any known method. The phosphinic acids may be reacted in aqueous solution with metal carbonates, metal hydroxides, or metal oxides. The salts of the phosphinic acid may be added with other components by both mixing and then melting during compounding, homogenized in a melt of the components, added directly into the compounding, and any other known method. The compounding may be done with a compounding assembly, such as a twin screw extruder.

Phosphinic acids which are suitable constituents of the phosphinic salts may include, for example, dimethylphosphinic acid, ethylmethylphosphinic acid, diethylphosphinic acid, methyl-n-propylphosphinic acid, methanedi (methylphosphinic acid), benzene-1,4-(dimethylphosphinic acid), methylphenylphosphinic acid, diphenylphosphinic acid.

The phosphinic acid (phosphinate) salts can be included at any concentration. For example, in embodiments,

Embodiments of the invention are not limited by the type of phosphonate component and the compositions described herein can include polyphosphonates, random copolyphosphonates, oligophosphonates, co-oligo(phosphonate ester)s, or co-oligo(phosphonate carbonate)s, and in certain embodiments, the phosphonate component may have the structures described and claimed in U.S. Pat. Nos. 6,861,499, 7,816,486, 7,645,850, and 7,838,604 and U.S. Publication No. 2009/0032770, each of which are hereby incorporated by reference in their entireties.

Such phosphonate components may include repeating units derived from diaryl alkylphosphonates or diaryl arylphosphonates. For example, in some embodiments, such phosphonate components include structural units illustrated by Formula I:

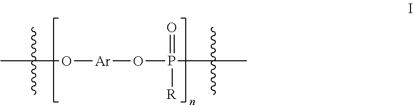

where Ar is an aromatic group and —O—Ar—O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges.

In certain embodiments, the phosphonate component may be a polyphosphonate containing long claims of the structural unit of Formula I. In some embodiments, the polyphosphonates may have a weight average molecular weight (Mw) of about 10,000 g/mole to about 100,000 g/mole as determined by ηᵣₑₗ or GPC, and in other embodiments, the polyphosphonates may have a Mw of from about 12,000 to about 80,000 g/mole as determined by ηᵣₑₗ or GPC. The number average molecular weight (Mn) in such embodiments may be from about 5,000 g/mole to about 50,000 g/mole, or from about 8,000 g/mole to about 15,000 g/mole, and in certain embodiments the Mn may be greater than about 9,000 g/mole. The narrow molecular weight distribution (i.e., Mw/Mn) of such polyphosphonates may be from about 2 to about 7 in some embodiments and from about 2 to about 5 in other embodiments. In still other embodiments, the polyphosphonates may have a relative viscosity of from about 1.10 to about 1.40.

In some embodiments, the phosphonate component may be a random copoly(phosphonate carbonate). These random copoly(phosphonate carbonate)s may include repeating units derived from at least 20 mole percent high purity diaryl alkylphosphonate or optionally substituted diaryl alkylphosphonate, one or more diaryl carbonate, and one or more aromatic dihydroxide, wherein the mole percent of the high purity diaryl alkylphosphonate is based on the total amount of transesterification components, i.e., total diaryl alkylphosphonate and total diaryl carbonate. As indicated by the term “random” the monomers of the copoly(phosphonate carbonate)s of various embodiments are incorporated into polymer chain randomly. Therefore, the polymer chain may include alternating phosphonate and carbonate monomers linked by an aromatic dihydroxide and/or various segments in which several phosphonate or several carbonate monomers form oligophosphonate or polyphosphonate or oligocarbonate or polycarbonate segments. Additionally, the length of various oligo or polyphosphonate oligo or polycarbonate segments may vary within individual copoly(phosphonate carbonate)s.

The phosphonate and carbonate content of the copoly(phosphonate carbonate)s may vary among embodiments, and embodiments are not limited by the phosphonate and/or carbonate content or range of phosphonate and/or carbonate content. For example, in some embodiments, the copoly(phosphonate carbonate)s may have a phosphorus content, which is indicative of the phosphonate content of from about 1% to about 20% by weight of the total copoly(phosphonate carbonate), and in other embodiments, the phosphorous content of the copoly(phosphonate carbonate)s of the invention may be from about 2% to about 10% by weight of the total polymer.

The copoly(phosphonate carbonate)s of various embodiments exhibit both a high molecular weight and a narrow molecular weight distribution (i.e., low polydispersity). For example, in some embodiments, the copoly(phosphonate carbonate)s may have a weight average molecular weight (Mw) of about 10,000 g/mole to about 100,000 g/mole as determined by ηᵣₑₗ or GPC, and in other embodiments, the copoly(phosphonate carbonate)s may have a Mw of from about 12,000 to about 80,000 g/mole as determined by ηᵣₑₗ or GPC. The number average molecular weight (Mn) in such embodiments may be from about 5,000 g/mole to about 50,000 g/mole, or from about 8,000 g/mole to about 15,000 g/mole, and in certain embodiments the Mn may be greater than about 9,000 g/mole. The narrow molecular weight distribution (i.e., Mw/Mn) of such copoly(phosphonate carbonate)s may be from about 2 to about 7 in some embodiments and from about 2 to about 5 in other embodiments. In still other embodiments, the random copoly(phosphonate carbonate)s may have a relative viscosity of from about 1.10 to about 1.40.

In other embodiments, the copoly(phosphonate carbonate)s, co-oligo(phosphonate carbonate)s, or co-oligo(phosphonate ester)s, may have structures such as, but not limited to, those structures of Formulae II and III, respectively:

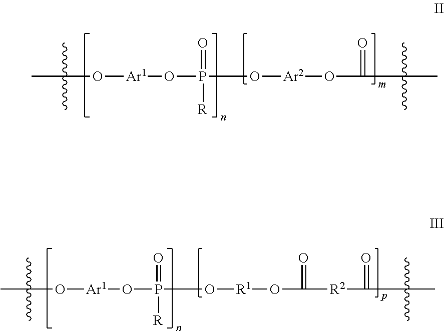

and combinations thereof, where Ar, Ar¹, and Ar² are each, independently, an aromatic group and —O—Ar—O— may be derived from a dihydroxy compound having one or more, optionally substituted aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohex ane, or combinations of these, R is a C₁₋₂₀ alkyl, C₂₋₂₀ alkene, C₂₋₂₀ alkyne, C₅₋₂₀ cycloalkyl, or C₆₋₂₀ aryl, R¹ and R² are aliphatic or aromatic hydrocarbons, and each m, n, and p can be the same or different and can, independently, be an integer from 1 to about 20, 1 to about 10, or 2 to about 5, or any integer between these ranges. In certain embodiments, each m, n and p are about equal and generally greater than 5 or less than 15.

As indicated by the term “random” the monomers of the “random co-oligo(phosphonate carbonate)s” or “random co-oligo(phosphonate ester)s of various embodiments are incorporated into polymer chain randomly, such that the oligomeric phosphonate chain can include alternating phosphonate and carbonate or ester monomers or short segments in which several phosphonate or carbonate or ester monomers are linked by an aromatic dihydroxide. The length of such segments may vary within individual random co-oligo(phosphonate carbonate)s or co-oligo(phosphonate ester)s.

In particular embodiments, the Ar, Ar¹, and Ar² may be derived from bisphenol A and R may be a methyl group providing polyphosphonates, oligomeric phosphonates, random and block co-oligo(phosphonate carbonate)s and co-oligo(phosphonate ester)s having reactive end-groups. Such compounds may have structures such as, but not limited to, structures of Formulae IV, V, and VI:

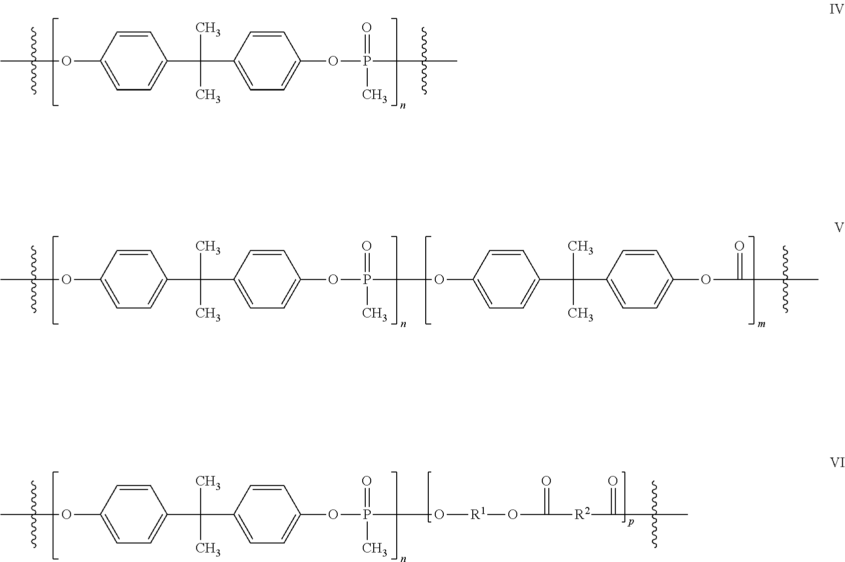

and combinations thereof, where each of m, n, p, and R¹ and R² are defined as described above. Such co-oligo(phosphonate ester), or co-oligo(phosphonate carbonate) may be block co-oligo(phosphonate ester), block co-oligo(phosphonate carbonate) in which each m, n, and p is greater than about 1, and the copolymers contain distinct repeating phosphonate and carbonate blocks or phosphonate and ester blocks. In other embodiments, the oligomeric co-oligo(phosphonate ester) or co-oligo(phosphonate carbonate) can be random copolymers in which each m, n, and p can vary and may be from n is an integer from 1 to about 30, from 1 to about 20, 1 to about 10, or 2 to about 5, where the total of m, n, and p is an integer from 1 to about 20, 1 to about 10, or 2 to about 5 or any integer between these ranges.

In some embodiments, bisphenol A may be the only (i.e., 100%) bisphenol used in the preparation of the phosphonate component and in other embodiments, bisphenol A may make up about 5% to about 90%, about 10% to about 80%, about 20% to about 70%, about 30% to about 60%, about 40% to about 50%, or a value between any of these ranges, with the remainder another bisphenol such as any one or more of the bisphenols described above.

The phosphorous content of phosphonate component may be controlled by the molecular weight (MW) of the bisphenol used in the oligomeric phosphonates, polyphosphonates, or copolyphosphonates. A lower molecular weight bisphenol may produce an oligomeric phosphonate, polyphosphonate, or copolyphosphonate with a higher phosphorus content. Bisphenols, such as resorcinol, hydroquinone, or a combination thereof or similar low molecular weight bisphenols may be used to make oligomeric phosphonates or polyphosphonates with high phosphorous content. The phosphorus content, expressed in terms of the weight percentage, of the phosphonate oligomers, phosphonates, or copolyphosphonates may be in the range from about 2% to about 18%, about 4% to about 16%, about 6% to about 14%, about 8% to about 12%, or a value between any of these ranges. In some embodiments, phosphonate oligomers, polyphosphonates, or copolyphosphonates prepared from bisphenol A or hydroquinone may have phosphorus contents of 10.8% and 18%, respectively. The phosphonate copolymers have a smaller amount of phosphorus content compared to the phosphonate oligomers and the polyphosphonates. In some embodiments, a bisphenol A based copolyphosphonate containing phosphonate and carbonate components wherein the phosphonate component is derived from the methyl diphenylphosphonate at a concentration of 20% compared to the total of the phosphonate and carbonate starting components may have about 2.30% phosphorus, about 2.35% phosphorus, about 2.38% phosphorus, about 2.40% phosphorus, or a range between any of these values (including endpoints).

With particular regard to co-oligo(phosphonate ester)s, co-oligo(phosphonate carbonate)s, block co-oligo(phosphonate ester)s, and block co-oligo(phosphonate carbonate)s, without wishing to be bound by theory, oligomers containing carbonate components, whether as carbonate blocks or randomly arranged carbonate monomers, may provide improved toughness over oligomers derived solely from phosphonates. Such co-oligomers may also provide higher glass transition temperature, T_{g}, and better heat stability over phosphonate oligomers.

The co-oligo(phosphonate carbonate)s of certain embodiments may be synthesized from at least 20 mole % diaryl alkylphosphonate or optionally substituted diaryl alkylphosphonate, one or more diaryl carbonate, and one or more aromatic dihydroxide, wherein the mole percent of the high purity diaryl alkylphosphonate is based on the total amount of transesterification components, i.e., total diaryl alkylphosphonate and total diaryl carbonate. Likewise, co-oligo(phosphonate ester)s of certain embodiments may be synthesized from at least 20 mole % diaryl alkylphosphonate or optionally substituted diaryl alkylphosphonate, one or more diaryl ester, and one or more aromatic dihydroxide, wherein the mole percent of the diaryl alkylphosphonate is based on the total amount of transesterification components.

The phosphonate and carbonate content of the oligomeric phosphonates, random or block co-oligo(phosphonate carbonate)s and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content, of from about 1% to about 12% by weight of the total oligomer, and in other embodiments, the phosphorous content may be from about 2% to about 10% by weight of the total oligomer.

In some embodiments, the molecular weight (weight average molecular weight as determined by gel permeation chromatography based on polystyrene calibration) range of the oligophosphonates, random or block co-oligo(phosphonate ester)s and co-oligo(phosphonate carbonate)s may be from about 500 g/mole to about 18,000 g/mole or any value within this range. In other embodiments, the molecular weight range may be from about 1500 g/mole to about 15,000 g/mole, about 3000 g/mole to about 10,000 g/mole, or any value within these ranges. In still other embodiments, the molecular weight range may be from about 700 g/mole to about 9000 g/mole, about 1000 g/mole to about 8000 g/mole, about 3000 g/mole to about 4000 g/mole, or any value within these ranges.

Hyperbranched oligomers of various embodiments have a highly branched structure and a high degree of functionality (i.e., chemical reactivity). The branched structure of such hyperbranched oligomers creates a high concentration of terminal groups, one at the end of nearly every branch that can include a reactive functional group such as hydroxyl end groups, epoxy end groups, vinyl end groups, vinyl ester end groups, isopropenyl end groups, isocyanate end groups, and the like. In some embodiments, the hyperbranched oligomers may have a unique combination of chemical and physical properties when compared to linear oligomeric phosphonates. For example, the high degree of branching can prevent crystallization and can render chain entanglement unlikely, so the hyperbranched oligomers can exhibit solubility in organic solvents and low solution viscosity and low melt viscosity especially when sheared.

In some embodiments, the hyperbranched oligomers can contain branches that are not perfectly (i.e., absolutely regular) arranged. For example, various branches on a single hyperbranched oligomer may have different lengths, functional group composition, and the like and combinations thereof. Consequently, in some embodiments, the hyperbranched oligomers of the invention can have a broad molecular weight distribution. In other embodiments, the hyperbranched oligomers of the invention may be perfectly branched, including branches that are nearly identical, and have a monodisperse molecular weight distribution.

The degree of branching for the hyperbranched oligomers of the invention can be defined as the number average fraction of branching groups per molecule, i.e., the ratio of terminal groups plus branch monomer units to the total number of terminal groups, branch monomer units, and linear monomer units. For linear oligomers, the degree of branching as defined by the number average fraction of branching groups per molecule is zero, and for ideal dendrimers, the degree of branching is one. Hyperbranched oligomers can have a degree of branching which is intermediate between that of linear oligomers and ideal dendrimers. For example, a degree of branching for hyperbranched oligomers may be from about 0.05 to about 1, about 0.25 to about 0.75, or about 0.3 to about 0.6, and in certain embodiments, the hyperbranched oligomers may have a number average fraction of branching groups about 0.5.

The hyperbranched oligomers of the invention may be generically represented by the following structure Formula VII:

B_{w}L-F)ᵥ VII

where B is the hyperbranched oligomer and w is the number of branches, v is an integer that is not zero, L is a linking group, and F is a reactive group.

The linking group (L) can be any moiety compatible with the chemistry of the monomers for the oligophosphonate, co-oligo(phosphonate ester), or co-oligo(phosphonate carbonate) described above. For example, in some embodiments, L can be any unit derived from an aryl or heteroaryl group including single aryl groups, biaryl groups, triaryl groups, tetraaryl groups, and so on. In other embodiments, L can be a covalent bond linking a functional group (F) directly to the hyperbranched oligomer, and in still other embodiments, L can be a C₁-C₁₀ alkyl, C₂-C₁₀ alkene, or C₂-C₁₀ alkyne that may or may not be branched.

The linking group (L) allows for attachment of one or more functional groups (F) to each branch termination of the hyperbranched oligomer. In some embodiments, each branch termination may have an attached linking group, and in other embodiments, one or more branch terminations of the hyperbranched oligomer (B) may not have an attached linking group. Such branch terminations without an attached linking group may terminate in a hydroxyl group or phenol group associated with the monomeric units of the hyperbranched oligomer. For branch terminations that include a linking group (L), each linking group may have from 0 to 5 or more associated functional groups. Thus, in some embodiments, one or more linking group of the reactive hyperbranched oligomer may have no attached functional groups, such that the branch termination associated with this linking group is substantially unreactive. In other embodiments, one or more linking group of the reactive hyperbranched oligomer may have one or more attached functional groups providing a branch termination that is potentially reactive with other monomers, oligomers, or polymers, and in still other embodiments, one or more linking groups of the reactive hyperbranched oligomer can have multiple attached functional groups. For example, two of the aryl groups associated with a triaryl group may include a functional group (F) with the third aryl group attaching the linking group to the hyperbranched polymer or oligomer. The functional group (F) may vary among embodiments and can be any chemical moiety capable of reacting with another chemical moiety. Non-limiting examples of functional groups (F) include hydroxyl, carboxylic acid, amine, cyanate, isocyanate, epoxy, glycidyl ether, vinyl, and the like and combinations thereof. The reactive hyperbranched oligomers of the present invention are reactive with a variety of functional groups such as epoxies, anhydrides, activated halides, carboxylic acids, carboxylic esters, isocyanates, aldehydes, vinyls, acetylenes, and silanes. These groups may be present on another monomer, oligomer, or polymer used in the preparation of a polymer composition.

The hyperbranched oligomer portion (B) of the general structure presented above may be any phosphonate containing hyperbranched oligomer. For example, in some embodiments, such hyperbranched oligomers may include repeating units derived from diaryl alkyl- or diaryl arylphosphonates, and certain embodiments, such hyperbranched oligomers may have a structure including units of Formula I:

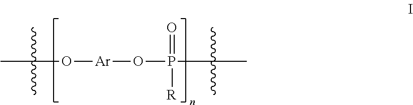

where Ar is an aromatic group and —O—Ar—O— may be derived from a compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges.

The hyperbranched oligomers (B) of such embodiments may further include units derived from branching agents or multifunctional aryl multifunctional biaryl groups, multifunctional triaryl groups, multifunctional tetra aryl, and so on. In some embodiments, the units derived from branching agents may be derived from, for example, polyfunctional acids, polyfunctional glycols, or acid/glycol hybrids. In other embodiments, the hyperbranched oligomeric phosphonates may have units derived from tri or tetrahydroxy aromatic compounds or triaryl or tetraaryl phosphoric acid esters, triaryl or tetraaryl carbonate or triaryl or tetraaryl esters or combinations thereof such as, but not limited to, trimesic acid, pyromellitic acid, trimellitic anhydride, pyromellitic anhydride, trimethylolpropane, dimethyl hydroxyl terephthalate, pentaerythritol, and the like and combinations thereof. Such branching agents provide branch points within the hyperbranched oligomeric phosphonate. In particular embodiments, the branching agent may be a triaryl phosphate such as, for example, those of Formula VIII:

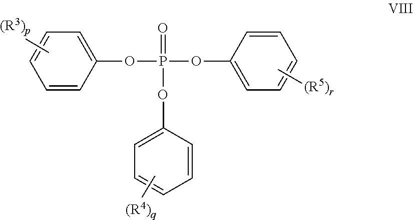

where each R³, R⁴, and R⁵ can, independently, be a hydrogen, C₁-C₄ alkyl of, and each of p, q, and r are independently integers of from 1 to 5.

The number of branches (w) may be directly proportional to the number of units derived from a branching agent and may be any integer from about 2 to about 20. In some embodiments, n may be an integer greater than 3, greater than 5, or greater than 10 or any value within these ranges, and in other embodiments, n may be from about 5 to about 20, about 5 to about 15, about 5 to about 10, or any value between these ranges.

The reactive hyperbranched phosphonates of certain embodiments may have a structure in which B is of Formula IX or Formula X:

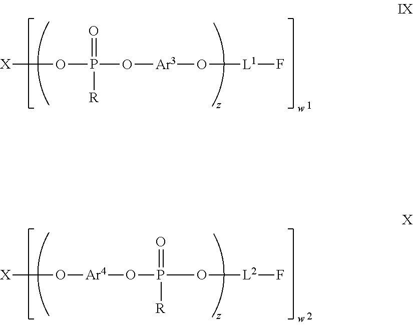

where each Ar³ and Ar⁴ are, independently, an aromatic group and —O—Ar³—O— and —O—Ar⁴—O— can be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, each L¹ and L² are, independently, a covalent bond or an aryl or heteroaryl group including single aryl groups, biaryl groups, triaryl groups, tetraaryl groups, and so on, R can be a C₁₋₂₀ alkyl, C₂₋₂₀ alkene, C₂₋₂₀ alkyne, C₅₋₂₀ cycloalkyl, or C₆₋₂₀ aryl, z is an integer from 1 to about 30, 1 to about 20, 1 to about 10, or 2 to about 5, or any integer between these ranges, and each w¹ and w² are, independently, 1 to 5. X may be derived from any branching agent described above. In some embodiments, X in an individual B may be the same molecule, such that branches having a structure of Formula VII and Formula VII may extend from the same branching agent (X) molecule. In particular embodiments, X may be a triarylphosphate of Formula VIII as described above. In other embodiments, two or more X may be linked as illustrated in Formula XI, Formula XII, or Formula XIII:

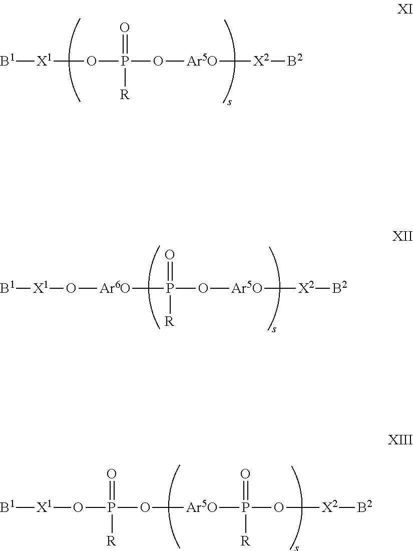

where each B¹ and B² are, independently, hyperbranched polymers as described above, each X¹ and X² are, independently, branching agents as described above, each Ar⁵ and Ar⁶ are, independently, an aromatic group and —OAr⁵—O— and —O—Ar⁶—O— can be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane or combinations of these, each R is as defined as above, and s is an integer of from 1 to about 30, 1 to about 20, 1 to about 10, or 2 to about 5, or any integer therebetween. In various embodiments, an individual reactive hyperbranched oligomer may have a structure in which portions of the oligomer can be any of Formula I, and VIII to XIII. Thus, embodiments encompass reactive hyperbranched oligomers in having any combination of the Formulae provided above. In other embodiments, a reactive hyperbranched oligomer may be composed of substantially one or two structures of the Formulae presented above. For example, a hyperbranched oligomer may be composed of two units derived from branching agents (X) linked by a structure of Formula XI with branches of Formula IX, or a hyperbranched oligomer may be composed of three or four branching agents linked by structures of Formulae XI and XIII with branches of structure Formula IX. Of course as discussed above, any combination of Formulae are possible and could be present in a single reactive hyperbranched oligomer.

An exemplary representation of a reactive hyperbranched oligomer of the invention is provided below:

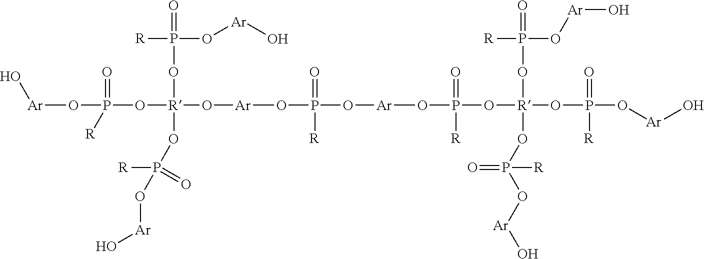

where Ar is an aryl or heteroaryl group, R is a C₁-C₄ alkyl group or an aryl group, and R′ is an alkyl or aromatic group derived from a branching agent.

In some embodiments, the molecular weight (weight average molecular weight as determined by gel permeation chromatography based on polystyrene calibration) range of the hyperbranched oligophosphonates, random or block co-oligo(phosphonate ester)s, and co-oligo(phosphonate carbonate)s may be from about 500 g/mole to about 18,000 g/mole or any value within this range. In other embodiments, the molecular weight range may be from about 1500 g/mole to about 15,000 g/mole, about 3000 g/mole to about 10,000 g/mole, or any value within these ranges. In still other embodiments, the molecular weight range may be from about 700 g/mole to about 9000 g/mole, about 1000 g/mole to about 8000 g/mole, about 3000 g/mole to about 4000 g/mole, or any value within these ranges.

The phosphonate and carbonate content of the hyperbranched oligomeric phosphonates, random or block co-oligo(phosphonate carbonate)ₛ, and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content, of from about 2% to about 12% by weight, 2% to about 10% by weight, or less than 10% by weight of the total oligomer.

The reactive hyperbranched oligomers of various embodiments may have greater than about 40% or greater than about 50% reactive end groups based on the total number of branch terminations as determined by known titration methods. In certain embodiments, the reactive hyperbranched oligomers may have greater than about 75% or greater than 90% of the reactive end groups based on the total number of branch terminations as determined by titration methods. In further embodiments, the reactive hyperbranched oligomers may have from about 40% to about 98% reactive end groups, about 50% to about 95% reactive end groups, or from about 60% to about 90% end groups based on the total number of branch terminations. As discussed above individual branch terminations may have more than one reactive end group. Therefore, in some embodiments, the reactive hyperbranched oligomers may have greater than 100% reactive end groups. As discussed above, the term “reactive end groups” is used to describe any chemical moiety at a branch termination that is capable of reacting with another chemical moiety. A large number of reactive functional groups are known in the art and encompassed by the invention. In particular embodiments, the reactive end groups may be hydroxyl, epoxy, vinyl, or isocyanate groups.

The oligomeric phosphonates of various embodiments including linear and hyperbranched oligophosphonates can exhibit a high molecular weight and/or a narrow molecular weight distribution (i.e., low polydispersity). For example, in some embodiments, the oligomeric phosphonates may have a weight average molecular weight (Mw) of about 1,000 g/mole to about 18,000 g/mole as determined by ηᵣₑₗ or GPC, and in other embodiments, the oligomeric phosphonates may have a Mw of from about 1,000 to about 15,000 g/mole as determined by ηᵣₑₗ or GPC. The number average molecular weight (Mn), in such embodiments, may be from about 1,000 g/mole to about 10,000 g/mole, or from about 1,000 g/mole to about 5,000 g/mole, and in certain embodiments the Mn may be greater than about 1,200 g/mole. The narrow molecular weight distribution (i.e., Mw/Mn) of such oligomeric phosphonates may be from about 1 to about 7 in some embodiments and from about 1 to about 5 in other embodiments. In still other embodiments, the co-oligo(phosphonate carbonate)s may have a relative viscosity (ηᵣₑₗ) of from about 1.01 to about 1.20. Without wishing to be bound by theory, the relatively high molecular weight and narrow molecular weight distribution of the oligomeric phosphonates of the invention may impart a superior combination of properties. For example, the oligomeric phosphonates of embodiments are extremely flame retardant and exhibit superior hydrolytic stability and can impart such characteristics on a polymer combined with the oligomeric phosphonates to produce polymer compositions such as those described below. In addition, the oligomeric phosphonates of embodiments, generally, exhibit an excellent combination of processing characteristics including, for example, good thermal and mechanical properties.

Each of phosphonate components described above can be made by any method. In certain embodiments, the phosphonate component may be made using a polycondensation or transesterification method, and in some embodiments, the transesterification catalyst used in such methods may be a non-neutral transesterification catalyst, such as, for example, phosphonium tetraphenylphenolate, metal phenolate, sodium phenolate, sodium or other metal salts of bisphenol A, ammonium phenolate, non-halogen containing transesterification catalysts, and the like, or a combination thereof.

The flame retardant mixture may include metal hydroxides or metal oxide hydroxides. Metal hydroxides or metal oxide hydroxides may include aluminum hydroxide, beryllium hydroxide, cobalt hydroxide, copper hydroxide, curium hydroxide, gold hydroxide, iron hydroxide, magnesium hydroxide, mercury hydroxide, nickel hydroxide, tin hydroxide, uranyl hydroxide, zinc hydroxide, zirconium hydroxide, gallium hydroxide, lead hydroxide, thallium hydroxide, alkaline earth metal hydroxides, nickel iron hydroxide, metal oxidehydroxides, or a combination thereof.

The flame retardant compositions may comprise additives, such as fillers, lubricants, surfactants, organic binders, polymeric binders, crosslinking agents, coupling agents, anti-dripping agents such as fluoropolymers, heat and light stabilizers, antistatic agents, antioxidants, nucleating agents, carbodiimide, colorants, inks, dyes, or a combination thereof. Additional additives may include UV absorbers and light stabilizers, 2-(2,′-hydroxyphenyl)-benzotriazoles, 2-hydroxybenzophenones, esters of optionally substituted benzoic acids, acrylates, nickel compounds, sterically hindered amines, oxalic acid diamides, metal deactivators, phosphites, phosphonites, compounds which destroy peroxide, basic costabilizers, nucleating agents, reinforcing agents, plasticizers, emulsifiers, pigments, optical brighteners, antistatics, blowing agents, or a combination thereof.

In some embodiments, the compositions may include nitrogen containing additives such as melamine, melamine derivatives, melamine salt or combinations thereof such as, for example, melamine cyanurate. In certain embodiments, nitrogen containing additives may be used in TPU containing compositions. The amount of nitrogen containing additive may be from about 0.1% to about 30% by weight, melamine, melamine derivatives, melamine salt or combinations thereof based on the total elastomer composition, about 0.1% to about 15% by weight, about 0.1% to about 10% by weight, about 0.1% to about 5% by weight.

In some embodiments, the compositions of the invention may include one or more additional additives such as, for example, reinforcing material, such as glass fibers, glass beads, or minerals, such as chalk, and anti-dripping agent such as polytetrafluoro ethylene or similar fluoropolymers (e.g., TEFLON® products) in quantities known to produce a desired effect.

The amount of the phosphinic acid salt added to the TPE-E composition may vary within wide limits. For example, TPE-E compositions may include from about 1% to about 30% by weight, based on the total elastomer composition, about 5% to about 25% by weight, based on the total elastomer composition, about 10% to about 25% by weight, about 15% to about 20% by weight, about 5% to about 15% by weight, or a value between any of these ranges. The ideal amount depends on the nature of the elastomer and on the type of other components, and on the character of the actual phosphinic acid salt used.

The amount of the phosphonate oligomer, polyphosphonate or copolyphosphonate included in the TPE-E composition may vary within wide limits. For example, the compositions of embodiments may include from about 1% to about 30% by weight phosphonate oligomer, polyphosphonate or copolyphosphonate, based on the total elastomer composition, about 1% to about 20% by weight, about 2% to about 15% by weight, about 2% to about 10%, about 1% to about 5%, or a value between any of these ranges. The amount depends on the nature of the elastomer, on the type of phosphinic salt used, and, on the type of metal hydroxide or metal oxide hydroxide used.

In embodiments in which metal hydroxide or metal oxide hydroxide are included in TPE-E compositions, the amount of the metal hydroxide or metal oxide hydroxide added to the TPE-E composition may vary within wide limits. For example, the compositions of embodiments may include from about 0.1% to about 30% by weight, metal hydroxide or metal oxide hydroxide based on the total elastomer composition, about 0.1% to about 15% by weight, about 0.1% to about 10% by weight, about 0.1% to about 5% by weight. The amount depends on the nature of the elastomer and on the type of phosphinic salt used, on the type phosphonate oligomer, polyphosphonate or copolyphosphonate used, and on the type of metal hydroxide or metal oxide hydroxide used.

In some embodiments, a TPE-E composition, may include from about 1% to about 30% by weight of phosphinic acid salt, from about 1% to about 30% by weight of phosphonate oligomer, polymer or copolymer, from about 0.1% to about 30% by weight of metal hydroxides or metal oxide hydroxides, and have about 20% to about 98% by weight of a thermoplastic polyester. In other embodiments, the TPE-E composition may include from about 5% to about 25% by weight of phosphinic acid salt, from about 1% to about 20% by weight of phosphonate oligomer, polymer or copolymer, from about 0.1% to about 15% by weight of metal hydroxides or metal oxide hydroxides, and have about 40% to about 94% by weight of a thermoplastic polyester.

In some embodiments, a TPE-E composition may include from about 10% to about 25% by weight of phosphinic acid salt, from about 1% to about 10% by weight of phosphonate oligomer, polymer or copolymer, from about 0.1% to about 10% by weight of metal hydroxides or metal oxide hydroxides, from about 55% to about 89% by weight of polyester, and conventional auxiliaries and additives, the entirety of the components adding up to give a total composition of 100% by weight. In particular embodiments, such TPE-E containing compositions may include from about 0.1% to about 20% by weight, about 0.5% to about 15% by weight, about 1% to about 10% by weight, about 0.1% to about 10% by weight, or any range or individual value encompassed by these ranges of melamine, melamine derivatives, melamine salt, or combinations thereof.

The amount of the phosphinic acid salt added to the TPU composition may vary within wide limits. For example, the amount used may be from about 1% to about 30% by weight phosphinic acid salt, based on the total elastomer composition, about 2% to about 25% by weight, based on the total elastomer composition, about 5% to about 20% by weight, about 5% to about 15% by weight, or a value between any of these ranges. The ideal amount depends on the nature of the elastomer and on the type of other components, and on the character of the actual phosphinic acid salt used.

The amount of the phosphonate oligomer, polyphosphonate, or copolyphosphonate added to the TPU composition may vary within wide limits. For example, the compositions of embodiments may include from about 1% to about 30% by weight phosphonate oligomer, polyphosphonate or copolyphosphonate, based on the total elastomer composition, about 1% to about 20% by weight, about 1% to about 15% by weight, about 1% to about 10% by weight, about 1% to about 5% by weight, about 2% to about 10% by weight, or a value between any of these ranges. The amount depends on the nature of the elastomer, on the type of phosphinic salt used, and, on the type of metal hydroxide or metal oxide hydroxide used.

In certain embodiments, TPU composition may include melamine, melamine derivatives, melamine salt, or combinations thereof. In such embodiments, the amount of the melamine, melamine derivatives, melamine salt, or combinations thereof added to the TPU composition may vary within wide limits. For example, the compositions of embodiments may include from about 0.1% to about 30% by weight melamine, melamine derivatives, melamine salt, or combinations thereof, based on the total elastomer composition, about 0.1% to about 15% by weight, about 0.1% to about 10% by weight, about 0.1% to about 5% by weight, about 5% to about 30% by weight, about 7.5% to about 20% by weight, or any range or individual concentration of melamine encompassed by these example ranges. The amount depends on the nature of the elastomer and on the type of phosphinic salt used, on the type phosphonate oligomer, polyphosphonate or copolyphosphonate used, and on the type of melamine, melamine derivatives, melamine salt, or combinations thereof used.

In some embodiments, a TPU composition, may include from about 1% to about 30% by weight of phosphinic acid salt, from about 1% to about 30% by weight of phosphonate oligomer, polymer or copolymer, from about 0.1% to about 30% by weight of metal hydroxides or metal oxide hydroxides, and have about 20% to about 98% by weight of a thermoplastic polyester. In other embodiments, the TPU composition may include from about 5% to about 25% by weight of phosphinic acid salt, from about 1% to about 20% by weight of phosphonate oligomer, polymer or copolymer, from about 0.1% to about 15% by weight of metal hydroxides or metal oxide hydroxides, and have about 40% to about 94% by weight of a thermoplastic polyester.

In certain embodiments, a TPU composition may include from about 10% to about 25% by weight of phosphinic acid salt, from about 1% to about 10% by weight of phosphonate oligomer, polymer or copolymer, from about 0.1% to about 10% by weight of melamine, melamine derivatives, melamine salt, or combinations thereof, from about 55% to about 89% by weight of polyester, and conventional auxiliaries and additives.

The flame retardant composition may be a participate mixture, a molten mixture, or may be a molded product obtained by solidifying the molten mixture. The solidified molten mixture may be in the form of a sheet or film. The participate mixture may be prepared by mixing the elastomer resin with the phosphinic acid salt, and the phosphonate compound, a metal hydroxide, and one or more additives through a conventional manner.

Further embodiments are directed to methods for making the compositions described above. There are many possible ways to mix the components, and the order of addition of each component may be in any sequence compatible with the desired mixing process.

In some embodiments, a method for incorporating phosphinic acid salt, and the phosphonate compound, a metal hydroxide, and optionally, one or more additional additives into a thermoplastic polyester may include premixing all of the constituents in the first step in the form of powder and/or pellets in a mixer, and then in the second step, the material may be homogenized in the polymer melt in a compounding assembly. Additional materials such as fillers may also be added and mixed in the first step. The melt may be drawn off in the form of an extrudate, cooled, and pelletized. In other embodiments, a method for incorporating phosphinic acid salt, and the phosphonate compound, a metal hydroxide, and optionally, one or more additives into a thermoplastic polyester may include introducing phosphinic acid salt, and the phosphonate compound, a metal hydroxide, and optionally one or more additives by way of a metering system directly into a compounding assembly in any desired order of sequence. The phosphonate oligomer, polymer or copolymer, and if desired, additional fillers, or components, may be added near the end of the extrusion process.

In further embodiments, a method for incorporating phosphinic acid salt, and the phosphonate compound, a metal hydroxide, and optionally, one or more additives may be a process including making pellets different in formulation, mixing the pellets in a certain ratio, and molding a product having a certain formulation from the resulting pellets, a process comprising directly feeding components in a molding machine. Mixing and melt-kneading of a particulate of the elastomer resin and other components during the preparation of the flame retardant composition to be used for the molded product may be advantageous to increase dispersion of other component(s).

The flame retardant composition may be melt-kneaded to mold a product with the use of a conventional manner such as an extrusion molding, an injection molding, or compression molding

In some embodiments, the elastomer compositions described herein may be flexible. In these embodiments, the flexural modulus of the TPE-E may be less than about 1000 MPa, about 25 MPa to about 700 MPa, about 30 MPa to about 500 MPa, about 50 MPa to about 400 MPa, about 100 MPa to about 300 MPa, or a value between any of these ranges. The desired modulus range will depend on the performance specifications of the final component.

In some embodiments, use of the flame retardant mixtures of phosphinic acid salt, the phosphonate compound, a metal hydroxide, and optionally, one or more additives, may be used for providing flame retardant properties to a variety of thermoplastic elastomers.

The flame retardant compositions described herein can be used for various purposes including, for example, as components or sub-assemblies in electric or electronic devices or parts, in mechanical devices or parts, in automotive devices or parts, as packaging material, and as a housing for electrical, mechanical and automotive assemblies or parts. In some embodiments, the flame retardant compositions may be used for covering an electric wire or cable, for example, a conducting wire such as a copper wire or a platinum wire, covering a power transmission wire or a wave-transmission wire such as an optical fiber cable, and the like. In other embodiments, the resin composition may have suitable adhesion to an electric wire. The process for covering wire or cable is not limited and may include a conventional covering process such as, for example, a extrusion molding or press processing. In some embodiments, the wire or cable may be produced by press processing an electric wire while holding the wire between the sheet- or film-like resin compositions.

The flame retardant elastomer compositions described herein may also be useful in the fabrication a wide variety of electronic components that are used to fabricate consumer electronics that may include computers, printers, modems, laptops computers, cell phones, video games, DVD players, stereos, and similar items.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Materials:

TPE-E—Thermoplastic polyester elastomer: Arnitel EM 400 from DSM
Estane ETE 50DT3—TPU from Lubrizol
Estane 58271—TPU from Lubrizol
PEARLTHANE 16N80—TPU from Merquinsa
E385M—TPU from Sunko Ink
H785M—TPU from Sunko Ink
Nofia® HM1100 (about 10.7 wt % of P), CO4000 (about 4.9 wt % of P), CO6000 (about 6.4 wt % of P), OL5000 (about 10.5 wt % of P)—phosphonate oligomers and polymers from FRX Polymers®
MC—melamine cyanurate from JLS Chemicals
MPP—melamine polyphosphate (about 13.8 wt % of P) from JLS Chemicals
ATH—aluminum trihydroxide from Nabaltec
Exolit OP1240—aluminum diethylphosphinate from Clariant (about 23.8 wt % of P)
Irafos 126—BASF
Irganox 1010—BASF
Polytetrafluoroethylene (PTFE) fine powder 6C from DuPont
Stabaxol P—Carbodiimide (Stabaxol) from Rhein Chemie

### Methods:

A 27 millimeter twin screw extruder (TSE) was used to compound a variety of compositions of thermoplastic polyester elastomers (TPE-E) and thermoplastic polyurethanes (TPU). All of the TPE-E compositions contained 0.1% of Irganox 1010 and 0.5% of polytetrafluoroethylene. The TPU compositions contained 0.2% of Irganox 1010 and 0.1% of Irgafos 126.

When compounding TPE-E, the temperature profile for the extruder started at 180° C. at the feeding block and gradually increased to 220° C. at the last zone. When compounding TPU, the temperature profiles were set differently for each grade according to the TPU manufacturer's recommended conditions. The compounding was conducted at 20-25 lbs/hours with a screw speed of around 100 rpm. All ingredients were pre-dried and mixed before putting into the feed hopper.

After adequate drying, the TPE-E molding compositions were processed in an injection molding machine with temperature settings from 200° C. to 210° C. to produce each test specimen. TPU molding compositions were processed in an injection molding machine with temperature settings according to TPU manufacturers' recommendation for that grade.

Shore hardness: Shore hardness was measured against A or D scale according ASTM D2240 using a hand held durometer.
MVR: Melt volume ratio (MVR) was measured on Dynisco LMI 4000 Melt Indexer.
Tensile Properties: Tensile testing was conducted according to ISO 527-2/1A at a rate of 50 millimeters/min.
UL94: All samples were tested for FR performance according the UL94 test protocol. Whether samples showed no drips, flammable drips or nonflammable drips is reported as ND, FD, NF, respectively. If a sample did not qualify for a V0, V1, or V2 rating, a qualification of NR (No Rating) was assigned.

### Comparative Examples 1-4

### Test Results for TPE-E Blends with Exolit OP1240 with Addition of ATH or MC

Testing results for TPE-E blends with Exolit OP1240 with or without ATH or MC are shown in Table 1. In addition to obtaining the best possible flame rating according UL94 (V0 at 1.6 mm), it is important that the blends fulfill a number of rheological and mechanical properties. It is preferred that the MVR, when measured at 230° C. and at a weight of 2.16 kg, is larger than about 7, even more preferably larger than about 10 cc/10 min. Furthermore, the tensile properties of the blends should be such that the tensile strength at break is preferably more than about 7 MPa, even more preferably more than about 10 MPa and the elongation at break is preferably more than about 120%, even more preferably more than about 150%. When using solid FR additives, like phosphinate salts, ATH, MC, and MPP that do not melt upon processing at high temperatures, especially the rheological and mechanical properties decrease dramatically when the total loading of solids becomes too high.

As shown, none of the compositions depicted in Table 1 reached an FR rating of V0 at 1.6 millimeters and also fulfilled all of the other requirements as described above. When using Exolit OP1240 at a fairly high concentration of 25 wt %, no V0 performance at 1.6 mm was obtained. When combining the Exolit with other FR additives like ATH or MC, it was only possible to reach a V0 performance when using 15 wt % of MC in addition to Exolit. However, for both combinations of Exolit with ATH and MC, the flow properties worsened and the MVR dropped to below 10 cc/10 min. Also, the stress at break decreased when using MC. All of the three additives are solids and as described above, the decrease of these properties is attributed to the increase in total solids

TABLE 1
TPE-E blends containing Exolit OP1240 with or without ATH orMC

| | CEX1 | CEX2 | CEX3 | CEX4 |
|---|---|---|---|---|
| Exolit OP1240 (wt %) | — | 25 | 20 | 20 |
| ATH (wt %) | — | — | 15 | — |
| MC (wt %) | — | — | — | 15 |
| Amount of P in blend (wt %) | 0 | 6.0 | 4.8 | 4.8 |
| Shore D Hardness | 33 | 39 | 45 | 45 |
| MVR (cc/10 min, 230° C./2.16 kg) | 35* | 10 | 7 | 3 |
| Stress at break (MPa) | 21* | >11 | 9 | 8 |
| Elongation at break (%) | 825* | >490 | 285 | 268 |
| UL-94 rating @ 1.6 mm | NR | V1 | V1 | V0 |
| t max (s) | >30 | 18 | 9 | 4 |
| t1 + t2 (s) | >250 | 57 | 58 | 18 |
| Drips (ND, NF, FD) | FD | ND | ND | ND |

*The data for the base Arnitel EM400 material were obtained from the data sheet from DSM

### Comparative Examples 5-8

### Test Results of TPE-E Blends Containing Nofia Polyphosphonates with Addition of ATH or MC

Testing results for TPE-E blends with Nofia polyphosphonates with or without ATH or MC are shown in Table 2. The Nofia polyphosphonates are meltable polymeric FR materials. As a result, the impact on flow and mechanical properties is much lower than when using solid, non-meltable FR additives as described in Table 1. Especially, this is demonstrated for CEX 5 and 6, where high MVRs and good tensile properties were obtained. Unfortunately, none of the formulations from Table 2 fulfilled the UL94 V0 criteria at 3.2 .mm.

TABLE 2
TPE-E blends containing Nofia polyphosphonates
with or without ATH orMC

| | CEX5 | CEX6 | CEX7 | CEX8 |
|---|---|---|---|---|
| Nofia HM1100 (wt %) | 20 | 20 | 20 | — |
| Nofia CO6000 (wt %) | — | — | — | 20 |
| ATH (wt %) | — | 20 | — | — |
| MC (wt %) | — | — | 20 | 20 |
| Amount of P in blend (wt %) | 2.1 | 2.1 | 2.1 | 1.3 |
| Shore D Hardness | 44 | 47 | 48 | 49 |
| MVR (cc/10 min, 230° C./2.16 kg) | 42 | 20 | 1.9 | 9.3 |
| Stress at break (MPa) | 15 | >12 | 10 | 11 |
| Elongation at break (%) | >440 | >479 | 121 | 210 |
| UL-94 rating @ 3.2 mm | NR | NR | V1 | NR |
| t max (s) | >30 | >30 | 30 | >30 |
| t1 + t2 (s) | >250 | >250 | 70 | >250 |
| Drips (ND, NF, FD) | FD | FD | ND | FD |

### Examples 1-11

### Test Results of TPE-E Blends Containing Nofia Polyphosphonates and Exolit OP1240 with Addition of ATH and/or MC

Testing results for TPE-E blends with Nofia polyphosphonates in combination with Exolit OP1240 with or without ATH and/or MC are shown in Table 3. The data in Table 3 demonstrate that when small portions of Exolit OP 1240 are replaced in TPE-E formulations with a small portion of a Nofia polyphosphonate, the blends can achieve an FR rating of V0 at 1.6 millimeters. Example 1, with 5% of Nofia CO6000 replacing 5% of Exolit OP1240 compared to Comparative Example 2 (CEX2), has a V0 rating at 1.6 millimeters, an elongation at break of 430% and higher flow with an MVR of 13 cc/10 min. Although the total weight content of FR additive is the same for Example 1 and Comparative Example 2 (25 wt %), the phosphorus content of Example 1 is about 5.1 wt % and thus lower than the phosphorous content of Comparative Example 2, which is about 6.0%. Nevertheless, the FR performance of Example 1 is improved compared to Comparative Example 2. This highlights the surprising effect between the phosphinate salt and the phosphonate polymers. It is thus possible to get an improved FR performance with a lower % P in the final formulation when combining the two types of FR additives than when having a higher % P in a formulation containing only one of the two FR additives.

As seen in Examples 2 and 3, further decreasing the % P in the final blend by increasing Nofia CO6000 and/or reducing Exolit OP1240 led to a lower FR rating of NR. Thus, when using no other FR additives (like ATH or MC) there is a minimum amount of % P of at least >4.2 wt % needed to fulfill the FR requirements in these TPE-E compositions.

TABLE 3
TPE-E blends containing Nofia polyphosphonates and Exolit OP1240 with or without
ATH and/or MC

| | EX1 | EX2 | EX3 | EX4 | EX5 | EX6 | EX7 | EX8 | EX9 | EX10 | EX11 |
|---|---|---|---|---|---|---|---|---|---|---|---|
| Exolit OP1240 (wt %) | 20 | 15 | 15 | 20 | 20 | 20 | 20 | 16 | 16 | 15 | 16 |
| Nofia CO4000 (wt %) | — | — | — | — | — | — | 5 | — | 4 | — | 4 |
| Nofia CO6000 (wt %) | 5 | 5 | 10 | 5 | 5 | 5 | — | 4 | — | 5 | |
| ATH (wt %) | — | — | — | 10 | 15 | 20 | 15 | 15 | 15 | 15 | 12 |
| MC (wt %) | — | — | — | — | — | — | — | — | — | 5 | 3 |
| Amount of P in blend (wt %) | 5.1 | 3.9 | 4.2 | 5.1 | 5.1 | 5.1 | 5.0 | 4.1 | 4.0 | 3.9 | 4.0 |
| Shore D Hardness | 39 | 41 | 44 | 44 | 47 | 50 | 48 | 45 | 45 | 49 | 47 |
| MVR (cc/10 min, | 13 | 17 | 18 | 7.7 | 5.8 | 4.5 | 7.1 | 9.3 | 9.3 | 7 | 8.1 |
| 230° C./2.16 kg) | | | | | | | | | | | |
| Stress at break (MPa) | 13 | >14 | 15 | 10 | 9 | 9 | 9 | 9 | 10 | 9 | 10 |
| Elongation at break (%) | 430 | >480 | 465 | 256 | 137 | 73 | 168 | 191 | 210 | 133 | 236 |
| UL-94 rating @ 1.6 mm | V0 | NR | NR | V0 | V0 | V0 | V0 | V0 | V0 | V0 | V0 |
| t max (s) | 6 | >30 | >30 | 8 | 8 | 5 | 4 | 7 | 9 | 5 | 5 |
| t1 + t2 (s) | 18 | 198 | >250 | 39 | 37 | 36 | 28 | 47 | 34 | 25 | 29 |
| Drips (ND, NF, FD) | ND | ND | FD | ND | ND | ND | ND | ND | ND | ND | ND |

Flame retardants, such as Exolit OP1240 and Nofia polyphosphonates, can be the more expensive ingredients in such compositions. Therefore, it is desired to lower the total loading of such flame retardant additives. It was found, that at lower flame retardant loadings the FR performance decreased as shown by comparing Example 2 to Example 1. It was shown in the comparative examples that ATH did not have a positive effect on the FR performance of TPE-E blends containing just Exolit OP1240 (CEX3) or Nofia phosphonate (CEX4). Surprisingly, it was found that ATH actually boosts the FR rating of TPE-E when both Exolit OP1240 and Nofia phosphonates are present in the formulation (EX8-9). Also, when adding both ATH and MC to the blends containing combinations of Exolit OP1240 and Nofia polyphosphonates, it is possible to obtain a V0 performance at 1.6 mm, where the rheological properties and the mechanical properties can be maintained at an acceptable level, which was not possible when MC was added to a TPE-E blend that contained only Exolit OP1240 or only a Nofia polyphosphonate.

### Comparative Examples 9-12

### and

### Examples 12-16

### Test Results of TPU Blends Based on Estane ETE 50DT3 Containing Nofia Phosphonate Oligomer and/or Exolit OP1240 with Addition of MC, MPP, or ATH

Testing results for TPU blends based on Estane ETE 50DT3 with Nofia phosphonate oligomer and/or Exolit OP1240 with MC, MPP, or ATH are shown in Table 4.

TABLE 4
TPU blends based on Estane ETE 50DT3 (polyether based, 50D) containing Nofia
polyphosphonates and/or Exolit OP1240 with MC, MPP, or ATH

| | CEX9 | CEX10 | CEX11 | CEX12 | EX12 | EX13 | EX14 | EX15 | EX16 |
|---|---|---|---|---|---|---|---|---|---|
| Exolit OP1240 (wt %) | 10 | 15 | — | — | 10 | 10 | 10 | 10 | 10 |
| Nofia OL5000 (wt %) | — | — | 10 | 15 | 5 | 2.5 | 5 | 5 | 5 |
| MC (wt %) | 15 | 15 | 20 | 25 | 15 | 15 | | 7.5 | |
| MPP (wt %) | | | | | | | 15 | 7.5 | |
| ATH (wt %) | | | | | | | | | 15 |
| Amount of P in blend (wt %) | 2.4 | 3.6 | 1.1 | 1.6 | 2.9 | 2.6 | 5.0 | 3.9 | 2.9 |
| Shore D Hardness | 61 | 63 | 65 | ND | 64 | 56 | 62 | 69 | 61 |
| MVR (cc/10 min, 220° C./1.2 kg) | 12.4 | 6.9 | 15.9 | 32 | 5.9 | 8.5 | 25.8 | 15.2 | 32 |
| Modulus (MPa) | 155 | 256 | 474 | 878 | 412 | 194 | 285 | 339 | 264 |
| Stress at break (MPa) | 30 | 23 | 35 | 23 | 30 | 25 | 22 | 25 | 18 |
| Elongation at break (%) | 342 | 268 | 322 | 170 | 292 | 302 | 251 | 264 | 269 |
| UL-94 rating @ 1.6 mm | V2 | V2 | V2 | V2 | V0 | V0 | V2 | V0 | V2 |
| t max (s) | 7 | 2 | 5 | 2 | 1 | 1 | 5 | 1 | 5 |
| t1 + t2 (s) | 18 | <6 | 35 | 13 | <5 | <5 | 12 | <5 | 17 |
| Drips (ND, NF, FD) | FD | FD | FD | FD | NF | NF | FD | NF | FD |

The TPUs that only contained Exolit OP1240 or Nofia OL5000 in combination with MC, obtained a V2 rating at 1.6 mm. However, by adding a combination of Nofia OL5000 and Exolit OP1240 in combination with MC, it is possible to reach a V0 rating, even at a lower total phosphorous content than when using only Exolit OP1240 with MC (Examples 12 and 13 versus comparative example 10). This again demonstrates the surprising effect of phosphinate salts and phosphonate compounds. Also, mechanical properties are improved, and thus, these new compositions show excellent combination of processing characteristics, mechanical properties, flame retardancy and cost.

As shown in Example 12 and Examples 14-16, TPU containing a combination of Exolit OP1240 and Nofia OL5000 can reach V0 at 1.6 mm when MC is present or with a combination of MC and MPP, but not with MPP alone, or with ATH. Compared to MC alone, the combination of MC and MPP has the benefit of a substantially higher flow.

### Examples 17-20

### Test Results for Blends Based on Different TPU Grades Containing Nofia Phosphonate Oligomers, Exolit OP1240, and MC

Testing results for blends based on different TPU grades containing Nofia phosphonate oligomers, Exolit OP1240, and MC are shown in Table 5.

TABLE 5
Test results for blends based on different TPU grades containing
Nofia phosphonate oligomers, Exolit OP1240, and MC

| | EX17 | EX18 | EX19 | EX20 |
|---|---|---|---|---|
| PEARLTHANE 16N80 | 72.2 | | | |
| (polyether based, 81A, wt %) | | | | |
| Estane 58271 (polyester based, 85A, wt %) | | 72.2 | | |
| E385M (polyether based, 85A, wt %) | | | 72.2 | |
| H785M (polyester based, 85A, wt %) | | | | 72.2 |
| Exolit OP1240 (wt %) | 10 | 10 | 10 | 10 |
| Nofia OL5000 (wt %) | 2.5 | 2.5 | 2.5 | 2.5 |
| MC (wt %) | 15 | 15 | 15 | 15 |
| Amount of P in blend (wt %) | 2.6 | 2.6 | 2.6 | 2.6 |
| Shore A Hardness | 90 | 91 | 92 | 93 |
| MVR (cc/10 min, 220° C./1.2 kg) | 26 | 21 | 16 | 13 |
| MVR (cc/10 min, 200° C./2.16 kg) | 10.6 | 5.8 | 6.8 | 6.1 |
| Modulus (MPa) | 35 | 35 | 31 | 38 |
| Stress at break (MPa) | >11 | >15 | >15 | >22 |
| Elongation at break (%) | >469 | >478 | >479 | >468 |
| UL 94 rating @ 1.6 mm | V0 | V0 | V0 | V0 |
| t max (s) | <1 | <1 | <1 | <1 |
| t1 + t2 (s) | <5 | <5 | <5 | <5 |
| Drips (ND, NF, FD) | NF | NF | NF | NF |

The results for Examples 13 and 17-20 demonstrate that the combination of Exolit OP1240 and Nofia OL5000 in the presence of MC is very robust against changes in the base resin. Both polyether and polyester based TPU reached a V0 at 1.6 mm and had excellent mechanical properties (i.e., low modulus and high elongation at break).

E385M and H785M were further formulated to optimize the loading of the synergists. The flame retardancy, mechanical property, melt flow as well as thermal and hydrolytic stabilities were investigated (Tables 6 and 7). As shown in Table 6 for ether based TPU, phosphonate oligomers and aluminum diethylphosphinate (DEPAL) again demonstrated a synergistic effect by obtaining better flame retardancy at lower P % than when DEPAL is used alone. Lower modulus and good elongation were achieved with phosphonate oligomer/DEPAL/MC combinations. For ester based TPU that are typically less flammable than polyether based TPUs, either phosphonate oligomer/MC or phosphonate oligomer/DEPAL/MC are able to provide V0 rating at 1.6 mm (Table 7). However, the phosphonate oligomer/DEPAL/MC combination is more robust, giving V0 at 0.8 mm at the higher DEPAL level.

TABLE 6
Formulation optimization for ether based E385M.

| | Sample ID | | | | | | | | |
|---|---|---|---|---|---|---|---|---|---|
| | E385M | EX21 | EX22 | EX23 | EX24 | EX25 | EX26 | EX27 | EX28 |
| DEPAL [wt %] | | 10 | 15 | 10 | 8.5 | 8 | 6 | 6 | 4 |
| Nofia OL5000 | | | | 10 | 4 | 2 | 2 | 2 | 1 |
| [wt %] | | | | | | | | | |
| MC [wt %] | | 15 | 15 | 15 | 15 | 15 | 15 | 15 | 30 |
| Stabaxol P [wt %] | — | — | — | — | — | — | 1.5 | — | — |
| Wt % P in blend | | 2.4 | 3.5 | 3.4 | 2.4 | 2.1 | 2.1 | 1.6 | 1.1 |
| UL 94 at 1.6 mm | | V2 | V2 | V0 | V0 | V0 | V0 | V0 | V2 |
| Shore A Hardness | 85 | 92 | 94 | 94 | 92 | 91 | 92 | 92 | 95 |
| Modulus, MPa | | 40 | 59 | 70 | 30 | 35 | 36 | 33 | 70 |
| Tensile strength, | 45 | >18 | >12 | >19 | >16 | >20 | >16 | >16 | 12 |
| MPa | | | | | | | | | |
| 121° C., 7 d | — | — | — | — | — | >15 (75%) | >15 (94%) | — | — |
| 80° C., 21 d, water | — | — | — | — | — | >8 (40%) | >10 (63%) | — | — |
| Elongation@ break % | 510 | >470 | >460 | >470 | >460 | >470 | >460 | >460 | 360 |
| 121° C., 7 d | — | — | — | — | — | >480 (>100%) | >490 (>100%) | — | — |
| 80° C., 21 d, water | — | — | — | — | — | >470 (100%) | >480 (100%) | — | — |
| MVR | 7 | 7 | 7 | 6 | 8 | 7 | 7 | 7 | 6 |
| (200° C./2.16 kg) | | | | | | | | | |

TABLE 7
Formulation optimization for ester based H785M.

| | Sample ID | | | | | | |
|---|---|---|---|---|---|---|---|
| | H785M | EX29 | EX30 | EX31 | EX32 | EX33 | EX34 |
| Nofia OL5000 [wt %] | | | 5 | 5 | 3 | 2 | 2.5 |
| DEPAL [wt %] | | | | | | 6 | 10 |
| MC [wt %] | | 30 | 30 | 20 | 20 | 15 | 15 |
| Wt % P in the blend | | 0 | 0.5 | 0.5 | 0.3 | 1.6 | 2.6 |
| UL 94 at 1.6 mm | | V2 | V0 | V0 | V2 | V0 | V0 |
| UL 94 at 0.8 mm | | | V2 | | | V2 | V0 |
| Shore A | 85 | 95 | | 91 | 93 | 93 | 93 |
| Modulus [MPa] | | 59 | 50 | 33 | | 35 | 38 |
| Stress @ 100% [MPa] | | 13 | 13 | 10 | | 9 | 8 |
| 121° C., 7 d | | | 10 (77%) | | | 10 (111%) | |
| Stress @ 300% [MPa] | | 20 | 20 | 16 | | 15 | 15 |
| 121° C., 7 d | | | 13 (65%) | | | 15 (100%) | |
| Tensile strength [MPa] | 49 | 29 | >29 | >24 | | >22 | >22 |
| 121° C., 7 d | | | >19 (66%) | | | >24 (109%) | |
| Elongation at break [%} | 530 | 465 | >470 | >460 | | >460 | >468 |
| 121° C., 7 d | | | >490 (104%) | | | >490 (106%) | |
| MVR (200 C/2.16 kg) | 7 | 4 | 6 | 7 | 7 | 5 | 6 |

Table 6 also shows that after heat-aging at 121° C. for 7 days, both ether and ester based TPUs with the phosphonate oligomer/DEPAL/MC combination had >65% retention of mechanical properties (EX25, 26, 30, and 32), although ester based TPU formulation had better retention in tensile strength than ether based TPU formulation.

Tensile bars were also immersed in 80° C. water for 21 days to study the hydrolytic stability. Ester based TPU with the phosphonate oligomer/DEPAL/MC combination with or without acid scavenger (i.e., Stabaxol) fell apart during the test. Ether based TPU had better hydrolytic stability than the ester based TPU. However, only when Stabaxol P was added (EX 26 vs. EX 27), the sample retained more than 50% of the mechanical properties at the end of the testing, as shown in Table 7.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, etc. As will also be understood by one skilled in the art, all language such as “up to,” “at least,” and the like include the number recited and refer to ranges which can be subsequently broken down into subranges as discussed above. Finally, as will be understood by one skilled in the art, a range includes each individual member.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A plastic molding composition comprising a thermoplastic polyurethane, about 2 wt. % to about 25 wt. % phosphinate salt, and about 1 wt. % to about 15 wt. % of a phosphonate component selected from the group consisting of oligomeric phosphonates, polyphosphonates, and copolyphosphonates, wherein the plastic molding composition has a phosphorous content of about 5 wt. % to about 0.5 wt. %.

2. The composition of claim 1, wherein the phosphonate component comprises polymer or oligomer having units of Formula I: 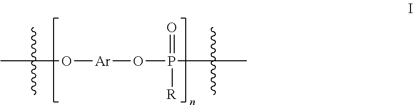
wherein:
Ar is an aromatic group;
R is a C₁₋₂₀ alkyl, C₂₋₂₀ alkene, C₂₋₂₀ alkyne, C₅₋₂₀ cycloalkyl, or C₆₋₂₀ aryl; and
n is an integer from 1 to about 20.

3. The composition of claim 3, wherein —O—Ar—O— is derived from a compound selected from the group consisting of resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof.

4. The composition of claim 1, wherein the phosphonate component is a copolyphosphonate having a ratio of phosphonate to carbonate of about 95% to 5% to about 40% to 60%.

5. The composition of claim 1, wherein the phosphinate salt is aluminum diethylphosphinate.

6. The composition of claim 1, wherein the composition comprises about 0.1 wt. % to about 30 wt. % of a melamine containing component.

7. The composition of claim 6, wherein the melamine containing component is melamine cyanurate, melamine polyphosphate, and combinations thereof.

8. The composition of claim 1, further comprising a metal hydroxide or metal oxide hydroxide.

9. The composition of claim 1, further comprising glass fiber, carbon fiber, inorganic fiber, organic fiber, fillers, surfactants, organic binders, polymeric binders, crosslinking agents, coupling agents, anti-dripping agents, colorants, inks, dyes, antioxidants, anti-hydrolysis agents, or combinations thereof.

10. An article of manufacture comprising the composition of claim 1.

11. The article of manufacture of claim 10, wherein the article is a fiber, a film, an extruded sheet, a coating, an adhesive, a molding, a foam, a fiber reinforced article, or a part of a wire or cable.

12. A plastic molding composition comprising a thermoplastic polyester elastomer, about 5 wt. % to about 25 wt. % phosphinate salt, about 2 wt. % to about 15 wt. % of a phosphonate component selected from the group consisting of oligomeric phosphonates, polyphosphonates, and copolyphosphonates, and about 0.1 wt. % to about 30 wt. % of a metal hydroxide or metal oxide hydroxide.

13. The composition of claim 12, wherein the metal hydroxide or metal oxide hydroxide is aluminum hydroxide.

14. The composition of claim 12, wherein the phosphonate component comprises polymer or oligomer having units of Formula I: 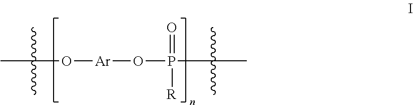
wherein:
Ar is an aromatic group;
R is a C₁₋₂₀ alkyl, C₂₋₂₀ alkene, C₂₋₂₀ alkyne, C₅₋₂₀ cycloalkyl, or C₆₋₂₀ aryl; and
n is an integer from 1 to about 20.

15. The composition of claim 14, wherein —O—Ar—O— is derived from a compound selected from the group consisting of resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof.

16. The composition of claim 12, wherein the phosphonate component is a copolyphosphonate having a ratio of phosphonate to carbonate of about 95% to 5% to about 40% to 60%.

17. The composition of claim 12, wherein the phosphinate salt is aluminum diethylphosphinate.

18. The composition of claim 12, wherein the composition comprises about 0.1 wt. % to about 10 wt. % of a melamine containing component.

19. The composition of claim 18, wherein the melamine containing component is melamine cyanurate, melamine polyphosphate, and combinations thereof.

20. The composition of claim 12, further comprising glass fiber, carbon fiber, inorganic fiber, organic fiber, fillers, surfactants, organic binders, polymeric binders, crosslinking agents, coupling agents, anti-dripping agents, colorants, inks, dyes, antioxidants, anti-hydrolysis agents, or combinations thereof.

21. An article of manufacture comprising the composition of claim 12.

22. The article of manufacture of claim 21, wherein the article is a fiber, a film, an extruded sheet, a coating, an adhesive, a molding, a foam, a fiber reinforced article, or a part of a wire or cable.
